(19) United States
(12) Patent Application Publication
(10) Pub. No.: US 2005/0284405 A1
(43) Pub. Date: Dec. 29, 2005

(54) Animal carrier

(76) Inventors: Sara Pomakoy-Poole, McLean, VA (US); Richard L. Adams JR., Oakton, VA (US)

Correspondence Address: David D. Beatty;Myers Bigel Sibley & Sajovec, P.A., P.O. Box 37428, Raleigh, NC, 27627, US

(21) Appl. No.: 11/133,860

(22) Filed: May 20, 2005

Related U.S. Application Data
(60) Provisional application No. 60/573,972, filed on May 24, 2004.

(51) Int. Cl. A01K 1/03

(52) U.S. Cl. 119/497

(57) ABSTRACT

An animal carrier for transporting an animal includes a body defining a chamber adapted to hold the animal. A plurality of retractable wheels are operably connected to the body and selectively movable between a retracted position and a deployed position.

### RELATED APPLICATION

This application claims the benefit of priority from U.S. Provisional Patent Application No. 60/573,972, filed May 24, 2004, the disclosure of which is incorporated herein by reference in its entirety.

### FIELD OF THE INVENTION

The present invention relates to apparatus for handling animals and, more particularly, to animal carriers.

### BACKGROUND OF THE INVENTION

Animal carriers are commonly employed for transporting and containing animals such as dogs, cats and other relatively small pets or the like. In use, known carriers may suffer from various shortcomings in convenience, security, animal safety, and/or animal comfort.

### SUMMARY OF THE INVENTION

According to embodiments of the present invention, an animal carrier for transporting an animal includes a body defining a chamber adapted to hold the animal. A plurality of retractable wheels are operably connected to the body and selectively movable between a retracted position and a deployed position.

According to further embodiments of the present invention, an animal carrier for transporting an animal includes a body defining a chamber adapted to hold the animal. A retractable handle is operably connected to the body and movable between a stored position in the carrier and an extended position extending from the carrier.

According to further embodiments of the present invention, an animal carrier for transporting an animal includes a rigid body defining a chamber adapted to hold the animal. A liner is joined to an inner surface of the body and surrounds at least a portion of the chamber. The liner is adapted to provide cushioning and/or acoustic absorption for the animal.

According to further embodiments of the present invention, an animal carrier for transporting an animal includes a body defining a door opening and a chamber adapted to hold the animal. The animal further includes a Dutch door assembly including first and second doors selectively covering the door opening.

According to further embodiments of the present invention, an animal carrier for transporting an animal includes a body defining a chamber adapted to hold the animal. An electronic tracking device is mounted on the carrier.

According to further embodiments of the present invention, an animal carrier for transporting an animal includes a body defining a chamber adapted to hold the animal. A sensor is mounted on the carrier. The sensor is adapted to detect a condition of the carrier.

According to further embodiments of the present invention, an animal carrier for transporting an animal includes a body defining a chamber adapted to hold the animal. A sensor is mounted on the carrier. The sensor is adapted to detect a condition of an animal disposed in the chamber.

According to further embodiments of the present invention, an animal carrier for transporting an animal includes a body defining a chamber adapted to hold the animal. An intercom is mounted on the carrier.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a front perspective view of an animal carrier according to embodiments of the present invention;

FIG. 2 is a front perspective view of the animal carrier of FIG. 1 wherein top and bottom doors thereof are in an open position;

FIG. 3 is a front perspective view of the animal carrier of FIG. 1 wherein the top door is open and the bottom door is closed;

FIG. 4 is an exploded, front perspective view of the animal carrier of FIG. 1;

FIG. 5 is a cross-sectional view of a top portion of the animal carrier of FIG. 1 taken along the line 5-5 of FIG. 1 and showing an interior surface thereof;

FIG. 6 is a bottom perspective view of the animal carrier of FIG. 1;

FIG. 7 is a front perspective view of the animal carrier of FIG. 1 wherein a handle and wheels thereof are deployed;

FIG. 8 is a bottom perspective view of a wheel deployment system of the animal carrier of FIG. 1 in a deployed position;

FIG. 9 is a bottom perspective view of the wheel deployment system of FIG. 8 in a retracted position;

FIG. 10 is a front perspective view of an animal carrier according to further embodiments of the present invention, wherein a window closure thereof is in a closed position; and.

FIG. 11 is a front perspective view of the animal carrier of FIG. 10, wherein the window closure is in an open position.

### DETAILED DESCRIPTION OF EMBODIMENTS OF INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “lover”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

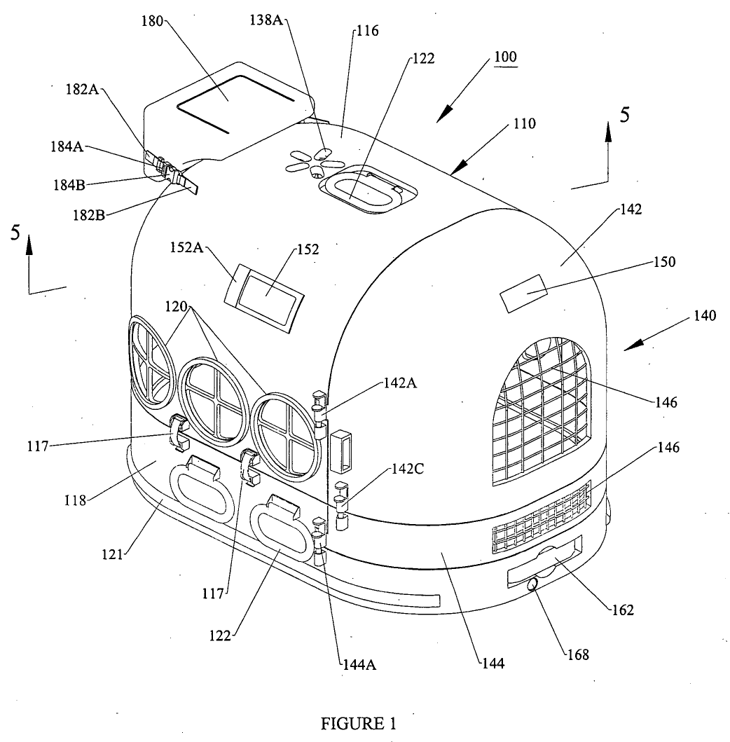

With reference to FIGS. 1-9, an animal kennel or carrier 100 according to embodiments of the present invention is shown therein. The carrier 100 may be used to hold and transport any suitable animals. For example, the carrier 100 may be used to transport a dog, cat or other domestic animal or animals. The size of the carrier 100 may be adapted to suitably accommodate the type or types of animals to be transported and/or held. According to some embodiments, the carrier 100 is adapted to carry animals weighing from about 25 to 200 pounds.

The carrier 100 may be advantageously used for traveling. The carrier 100 may reduce the risks associated with transporting an animal, especially on an airplane or the like. The carrier 100 may provide improved comfort for the animal as well as greater comfort and convenience for the owner or caretaker.

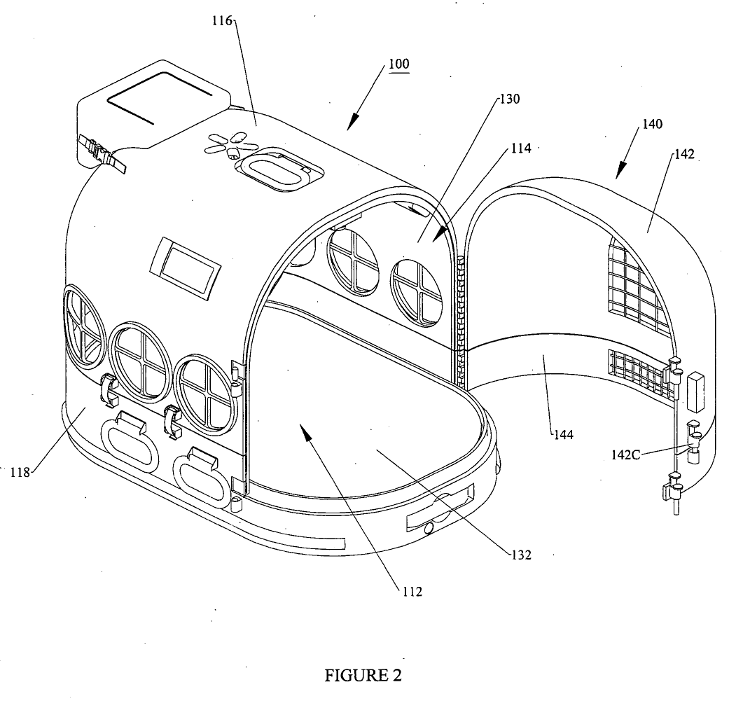

The carrier 100 includes an outer shell or body 110 defining an interior chamber 112 (FIG. 2) and a front door opening 114 (FIG. 2). The interior chamber 112 is sized to hold an animal. According to some embodiments, the volume of the interior chamber 112 is between about 1 and 18 cubic feet. According to some embodiments, the carrier 100 has a length in the range of from about 15 to 50 inches, a width in the range of from about 10 to 34 inches, and a height in the range of from about 6 to 37 inches.

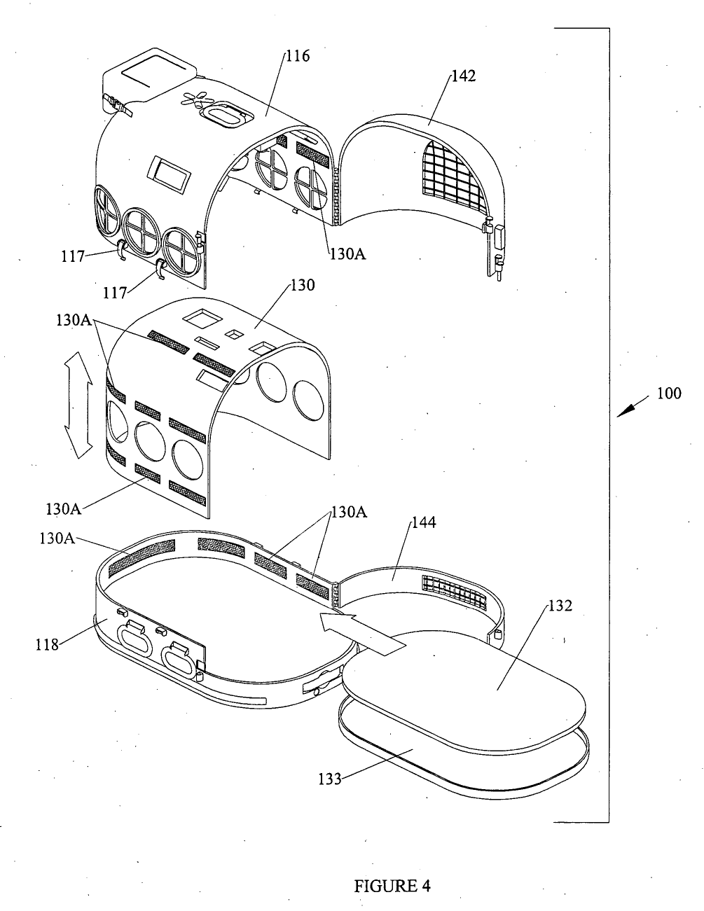

The body 110 includes a top portion 116 and a base portion 118. The body 110 may be unitarily formed or assembled from multiple pieces. According to some embodiments and as illustrated, the top portion 116 and the base portion 118 are respective pieces releasably coupled by buckles 117 or other suitable mechanisms. In this case, the top portion 116 can be removed from the base portion 118 as shown in FIG. 4 to facilitate placement of the animal into or removal of the animal from the carrier 100. The top portion 116 may also be removed to convert the base portion 118 to an open animal bed, for example, once the animal has reached its destination.

According to some embodiments and as illustrated, the top portion 116 is generally dome-shaped or elongated dome-shaped. According to some embodiments, the body 110 is substantially rigid. According to some embodiments, the body 110 is constructed so as to perform comparably with “hard case” luggage. For example, according to some embodiments, the carrier is formed of a rigid material and constructed such that it may be dropped from a height of at least 20 feet with a 200-pound weight inside without being crushed from the fall. According to some embodiments, the body 110 is formed of a polymeric material such as a molded thermoplastic polymer. Suitable polymeric materials may include ABS, polycarbonate, polyethylene, polystyrene, vinyl resin, and/or nylon and the like.

A plurality of small windows 120 are formed in the sides of the body 110. According to some embodiments, the windows 120 along with any further ventilation windows formed in the carrier 100 make up at least 14% of the total wall space of the carrier 100. According to some embodiments, at least one-third of the openings are located in the top half of the carrier 100. Bumpers or rims 121 are provided to prevent the ventilation windows 120 from being blocked by other articles. According to some embodiments, the bumpers 121 provide at least three-quarters of an inch of clearance. Preferably, the windows 120 are relatively small and each have an area of between about 1 and 9 square inches. Such relatively small windows may allow the animal more comfort by preventing the animal from seeing the surrounding activity, thus making the animal more calm during transport. Also, relatively small windows may allow less noise to come through the carrier to bother the animal, while still allowing for sufficient air flow into and through the chamber 112. According to some embodiments, some or all of the windows are open. According to further embodiments, some or all of the windows are covered with a screen that allows air flow but significantly obstructs or substantially fully blocks light.

A plurality of carrying and securing handles 122 extend from the body 110. The handles 122 provide for easy lifting and loading of the carrier 100. According to some embodiments, the handles are fitted so that they do not unduly protrude from the sides of the carrier 100. According to some embodiments, the handles 122 protrude to serve as bumpers in place of or in addition to the bumpers 121. According to some embodiments, a “push-in” interlock mechanism is provided to prevent the handles from flapping when not in use.

The handles 122 may provide improved safety by reducing the risk that the carrier will be dropped or mishandled. According to some embodiments, at least some of the handles 122 are fitted to the bottom half (e.g., on the base 118) of the carrier 100. According to some embodiments, the handles 122 are rounded, ovoid, with no rough edges and sufficiently thick to allow for an easy and comfortable grip. The articulation of the handles 122 should be limited to prevent pinching the hand of a person lifting the carrier 100. The handles 122 or a further feature of the carrier 100 may be used to secure the carrier 100 in an automobile or the like, for example, using an automobile seatbelt or seatbelts.

An interior padding or liner 130 (FIG. 2) is secured to the interior of the body 110 and surrounds at least a portion of the chamber 112. According to some embodiments, at least 25% of the chamber 112 is surrounded by the liner 130. The liner 130 may be or include an acoustic absorbing layer formed of a sound absorbing material that exhibits good acoustic absorption characteristics (i.e., effectively absorbs acoustic energy). According to some embodiments, the material of the liner 130 exhibits superior acoustic absorption as compared to the material of the body 110. The liner 130 may be formed of a polymeric material and may include a single or multiple layers. The liner 130 may also include a cushioning material. According to some embodiments, the liner 130 is formed of a layer of foam, fiber batt, carpet, rubber or a molded thermoplastic, which may be covered with a face layer of cloth, polymeric film, etc. on the side facing the chamber 112. According to some embodiments, the liner 130 has a thickness of between about ¼ and 4 inches. The liner 130 may be coupled or secured to the body 110 by any suitable means, for example, by adhesive and/or fasteners. The liner 130 may be removable for cleaning or washing. For example, as shown in FIG. 4, the liner 130 may be removably and replaceably coupled to the inner surface of the body 110 by VELCRO™ connector strips 130A.

A cushion 132, which is preferably removable, extends across the bottom of the chamber 112. The cushion 132 and the liner 130 may serve to protect the animal from injury if the carrier 100 is dropped or struck. The cushion 132 is held in a removable tray 133 that fits into or mounts on the base 118.

One or more glow lights 136 may be provided in the chamber 112 and secured to the inside of the carrier 100. The glow lights may continuously or selectively illuminate the chamber 112 to provide the animal with light for comfort during transport or kenneling. According to some embodiments, the glow lights 136 are passive (i.e., formed of a luminescent material that does not require electrical power). According to further embodiments, the lights may include light emitting diodes (LEDs), which may be powered by a battery, a solar cell and/or a motion driven generator, for example.

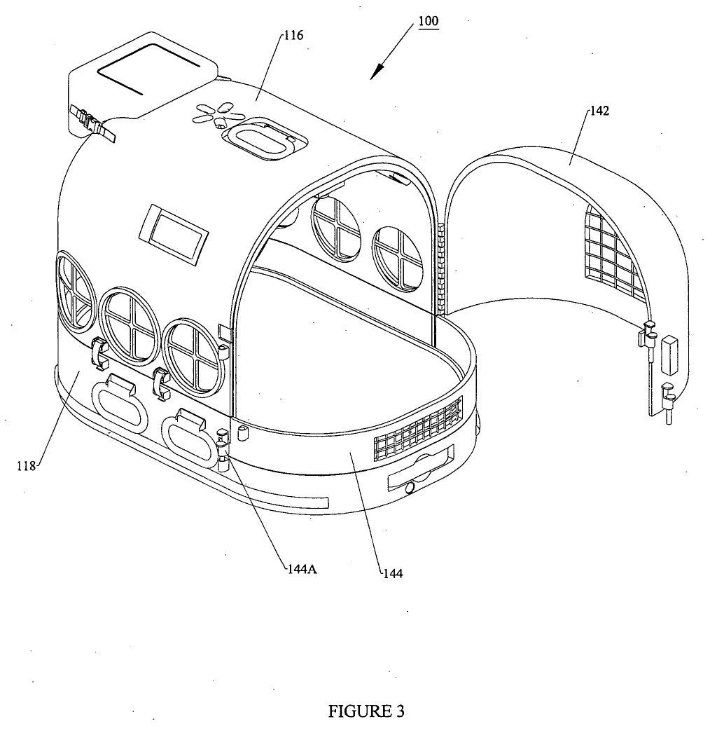

The carrier 100 further includes a door system or assembly 140 covering the door opening 114. The door assembly 140 includes a top door 142 with a latch 142A and a handle 142B. The door assembly 140 further includes a bottom door 144 having a latch 144A. A further latch 142C is provided between the doors 142 and 144. Together, the top door 142 and the bottom door 144 form a horizontally divided Dutch door assembly. The top and bottom doors 142, 144 can be operated independently and selectively opened separately or together to allow for easier feeding or comforting of the animal while reducing the risk of the animal escaping from the carrier 100. In particular, the doors 142, 144 can be interlocked by the latch 142C and opened as a single door as shown in FIG. 2. Alternatively, the bottom door 144 can remain locked in the closed position by the latch 144A and the top door 142 can be unlatched from the bottom door 144 and opened as shown in FIG. 3. A removable feeding mechanism or bowl may be attached to the bottom door 144 when an animal is being transported, for example. The latches 142A, 144A are preferably secure locks. The doors 142, 144 are preferably hingedly connected to the body 110 opposite the latches 142A, 144A. Screened windows 146 may be provided in the doors 142, 144 for ventilation, light, visibility, etc. The windows 146 may be transparent, translucent or opaque and may or may not allow air flow. A chain or cable may be provided that, when engaged, prevents the doors 142, 144 from opening fully or sufficiently to allow the animal to escape.

The carrier 100 may be provided with features for providing required and/or desired information, for example, regarding the animal. An identification plate or sleeve 150 (FIG. 1) is secured to the front of the carrier 100. An identification sleeve 152 is secured to the side of the carrier 100. The sleeve 152 (FIG. 1) may be a plastic pouch with a securable closure 152A (e.g., a snap or VELCRO™ closure) to enable the animal owner to print his/her destination address, emergency information numbers, animal medical information, animal feeding instructions, etc., on a piece of paper (e.g., a standard 8.5×11 sheet of paper) and insert the paper into the pouch. The sleeve 152 may be clear or partly clear and partly opaque to hide information. According to some embodiments, the sleeve 152 includes a clear pouch and an opaque flap that obfuscates the contents of the sleeve 152 except for the animal's name. Other indicia may be provided on the carrier 100 as well. For example, “LIVE ANIMAL” and/or “THIS END UP” may be embossed or otherwise indicated on the carrier 100.

The carrier 100 may further include a remote locating device 155 secured thereto. The remote locating device 155 may include, for example, a LOJACK™ RF transceiver, an RFID tag, or a GPS tracking module. The locating device may be adapted to communicate with or through a communications service such as the ON-STAR™ service. The locating device 155 may include a cellular telephone. The device 155 may be used to provide instant verification of the animal's location. For example, if an airline loses the carrier 100 and animal, the owner can expeditiously locate the city and location of the animal.

The locating device 155 may alternatively or additionally include a short range responder or receiver that can be triggered by a remote transmitter (e.g., similar to an automobile alarm or keyless entry system). The responder may be operative to emit sound and/or light (e.g., via a blinking LED) when triggered by the transmitter.

The carrier 100 may be provided with a sensor 156 adapted to detect conditions experienced by the carrier 100. More than one sensor 156 may be provided. The sensor may provide real time data and/or may record data from the sensor 156. The sensor 156 may detect a suitable environmental parameter or other type parameter. The sensor 156 may be a “rough handling” sensor that detects mechanical impact or trauma on the carrier 100. The sensor 156 may detect the attitude or orientation of the carrier 100 (e.g., a rollover sensor). Other parameters detected by the sensor 156 may include velocity, acceleration, air pressure, humidity, air composition or air quality (e.g., monitor the presence or concentrations of various chemical components such as oxygen, CO₂, volatile organics, etc.), temperature, and/or radiation. The sensor 156 may be a wetness sensor adapted and located to detect wetness of the liner 130 and/or the pad 132. The sensor 156 may be provided with relevant maximum and/or minimum settings and adapted to take suitably frequent samples or measurements.

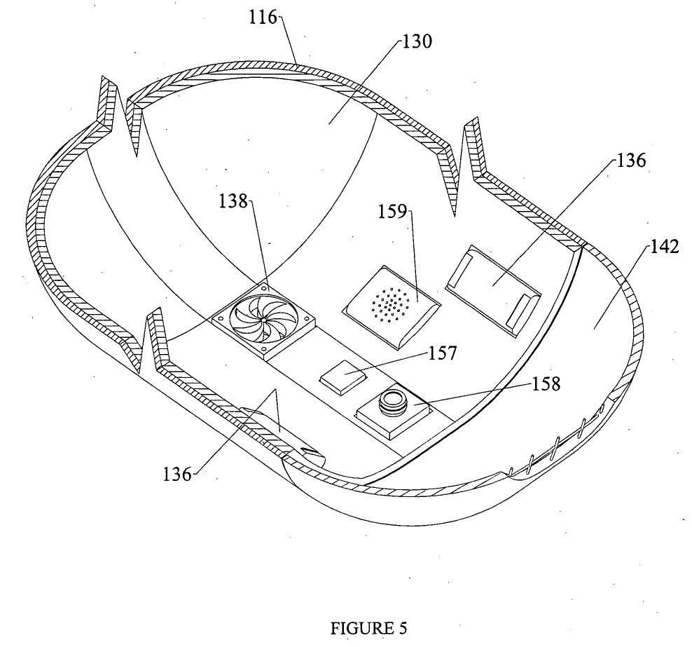

A sensor 157 (FIG. 5) may be provided on or in the carrier to monitor a characteristic relating to or indicative of the animal's health. For example, a non-contact infrared thermometer may be provided to monitor the animal's temperature. Such a sensor or sensors, as well as the sensors discussed above, may be operative to trigger a local or remote alarm.

A camera 158 (FIG. 3) is provided to allow the owner to monitor the animal in the chamber 112. The camera 158 may be a digital camera, for example. The camera 158 may be operatively connected to suitable electronics so that it is accessible by any suitable means. For example, the camera 158 may be accessible via a cellular telephone or using WiFi or some other suitable broadcast protocol allowing viewing on a personal computer device. The camera signal may be broadcasted using a VHF TV signal so that it could be viewed on a television.

A wireless intercom 159 is provided to allow the owner to communicate with the animal in the chamber 112 using a cellular telephone, FRS radio, or any other suitable wireless communicator.

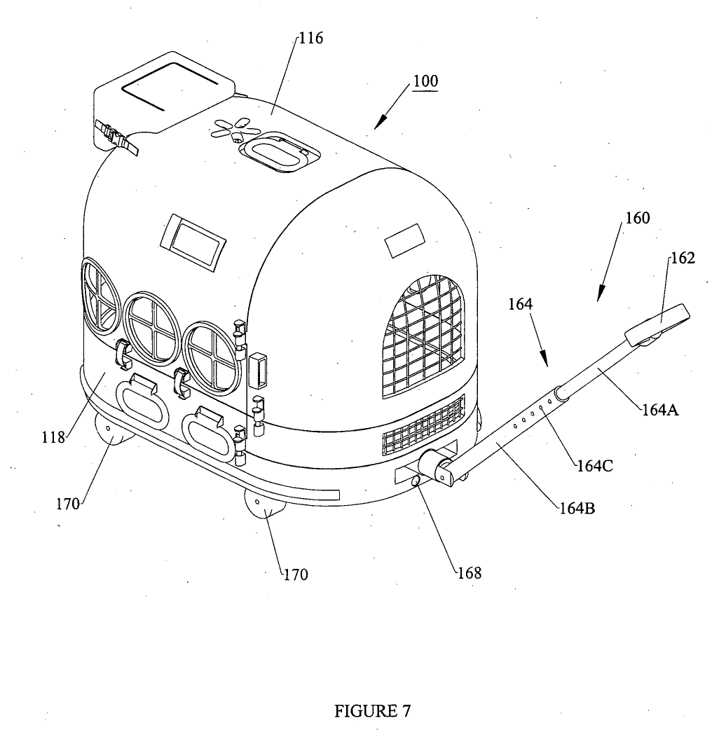

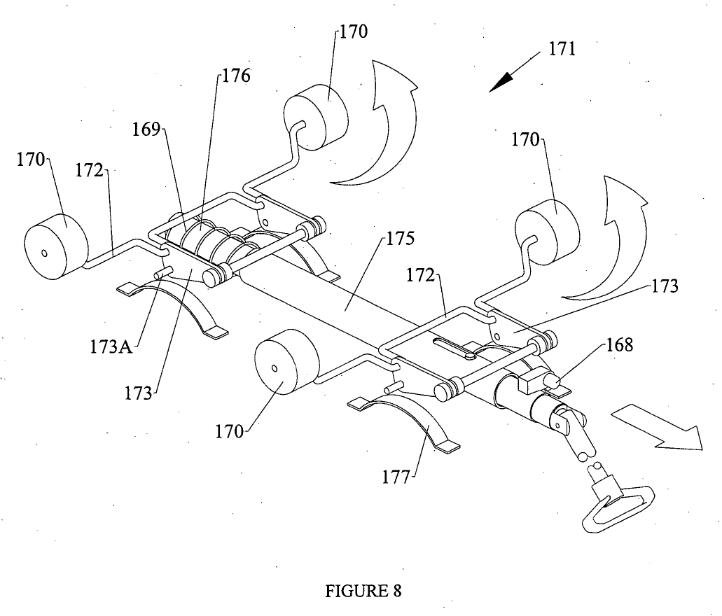

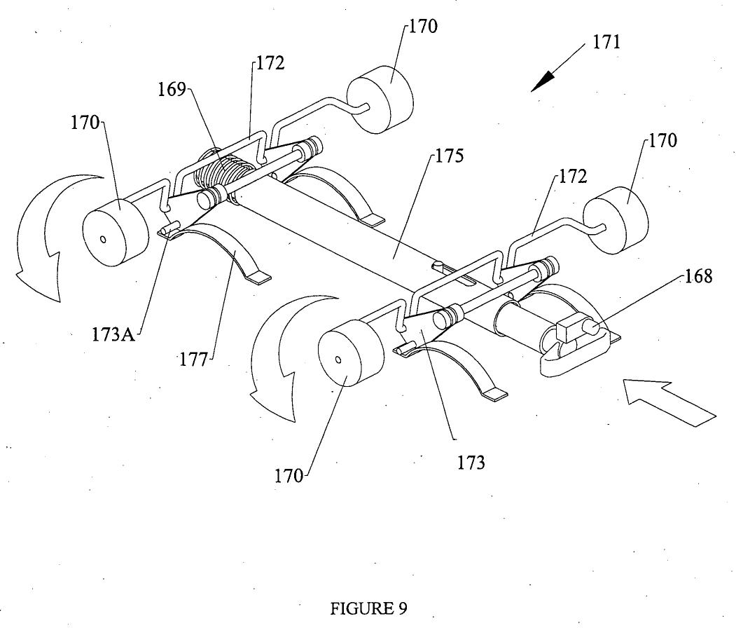

The carrier 100 includes a retractable handle 160. The retractable handle 160 includes a hand grip 162 and an extension arm 164. The retractable handle 160 is stowable in the base 118 or another part of the carrier 100. The handle 160 is shown in an extended position in FIG. 7 and in a retracted or stored position in FIGS. 1-4. A quick release button 168 is provided for accessing the handle 160 from the stored position. The handle 160 is spring loaded by a spring 169 (FIGS. 8 and 9).

The handle 160 may be foldable (e.g., with a hinge), telescoping, etc., or may be of a single fixed length. As shown, the handle 160 includes a pair of telescopingly coupled handle sections 164A, 164B that can be releasably secured in one or more extended positions by a latch pin 164C. According to some embodiments, the handle 160 is fully retractable into the base 118 when not in use. A foldable or telescoping handle may be beneficial or necessary in the case of small carriers 100 to allow for complete storage of the handle 160 in the carrier 100.

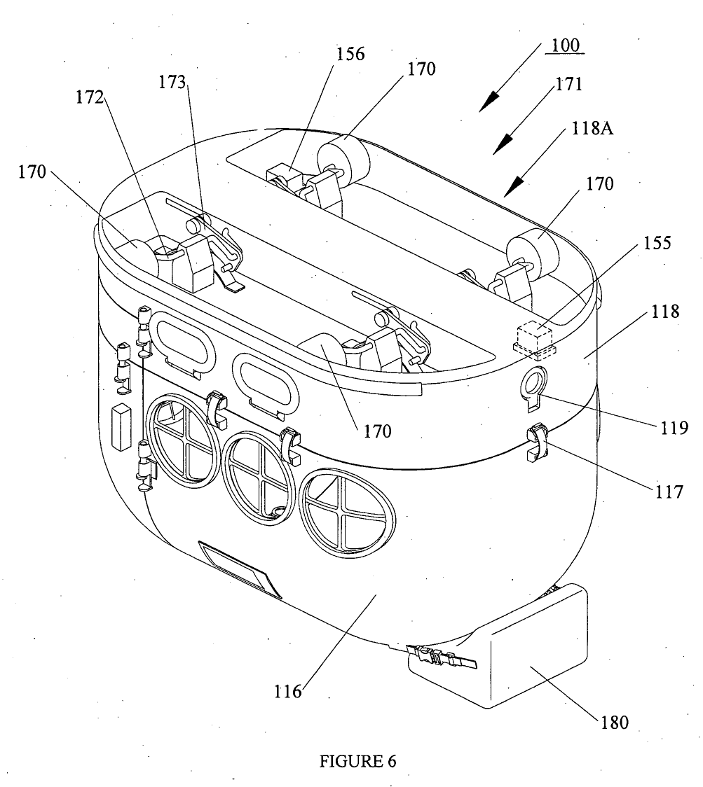

A plurality of wheels 170 (typically and as shown, four) are mounted on the base 118 of the carrier 100. A wheel deployment system 171 is provided to deploy (i.e., extend) the wheels 170 as shown in FIGS. 7 and 8 and to retract the wheels 170 as shown in FIGS. 6 and 9. When the wheels 170 are deployed, the carrier 100 can be conveniently rolled about. When the wheels 170 are retracted, the carrier 100 will remain stable and stationary. According to some embodiments, the wheels are fully retractable into the carrier 100 so that, when the wheels 170 are in the stored position, they do not project beyond the profile of the outer body 110. As shown in FIG. 6, the wheels 170 are fully retracted into cavities 118A defined in the base 118 when in the retracted position.

The wheels 170 may be deployed and retracted by manipulation of the handle 160. More particularly, the wheels 170 may retract when the handle 160 is inserted into the base 118, and may be deployed when the handle 160 is withdrawn from the base 118. Referring to FIGS. 8 and 9, the deployment system 171 includes pivot arms 172 on which the wheels 170 are mounted. The pivot arms 172 are coupled with linkages 173 that travel with a tubular slider 175 on a stationary guide rail 176 (FIG. 8). Each linkage 173 has a guide projection 173A that engages a respective guide ramp 177. When the handle 160 is withdrawn as shown in FIG. 8, the slider 175 is thereby pulled forward on the guide rail 176, causing the linkages 173 and the guide ramps 177 to pivot the wheels 170 in tandem into the deployed position as shown in FIGS. 7 and 8. When the handle 160 is re-inserted into the base 118, the slider 175 is slid rearwardly on the guide rail 176, causing the linkages 173 and the guide ramps 177 to pivot the wheels 170 back into the retracted position as shown in FIGS. 1, 6 and 9.

Additionally or alternatively, the wheels 170 may be retracted and deployed using another mechanism. Any suitable mechanism may be used for retracting and deploying the wheels 170. According to some embodiments, the wheel mechanism is fail-safe to ensure that the wheels are maintained in the locked and loaded position until deliberately released.

Rather than or in addition to being retractable, the wheels 170 may be lockable with manually or automatically engageable brakes. For example, brake arms may be pivotally secured to the base 118 and selectively transitioned from an unengaged position wherein the wheels 170 are allowed to rotate freely and an engaged position wherein the brakes prevent or inhibit rotation of the wheels 170. The brakes may be engaged and unengaged by withdrawal and insertion of the handle 160 into the base 118 as described above.

With reference to FIG. 1, an auxiliary pack 180 may be removably secured to the carrier 100. The pack 180 may be suitably sized and configured to allow the owner to pack animal necessities such as food, treats, medication, grooming supplies and the like therein. As shown, the pack 180 is secured to the outer body 110 by straps 182A and connectors 184A (secured to the straps 182A) and mating connectors 184B secured to the body 110 by straps 182B. The connectors 184A, 184B may be mating FASTEX™ quick-release buckles, for example. Other suitable structures may be employed for securing the pack 180 to the carrier 100. Preferably, the pack 180 is mounted to the body 110 such that the pack's movement is limited and the pack does not hinder ventilation. The size of the pack 180 may depend on the size of the carrier 100.

The carrier 100 may have a dedicated power supply to operate the electrical devices described herein and/or additional devices. The power supply may include one or more batteries. The carrier 100 may include a connector and appropriate electronics to access an automobile's power (e.g., a cigarette lighter connector) or an AC power supply (e.g., a common household electrical plug).

A fan 138 (FIG. 5) is mounted in or on the body 110 to provide forced ventilation of the chamber 112. The fan 138 may be powered by rising heat, a battery or any other suitable power source. The fan 138 may be a low power fan of the type employed in laptop computers. A vent opening 138A (FIG. 1) may be provided in the body 110 for exhausting the fan 138.

A coupler 119 (FIG. 6) is provided on the rear of the carrier 100 so that two carriers can be joined together for pulling in a train-like manner. The coupler 119 may be a ring that can be pivoted out for access or folded in for storage.

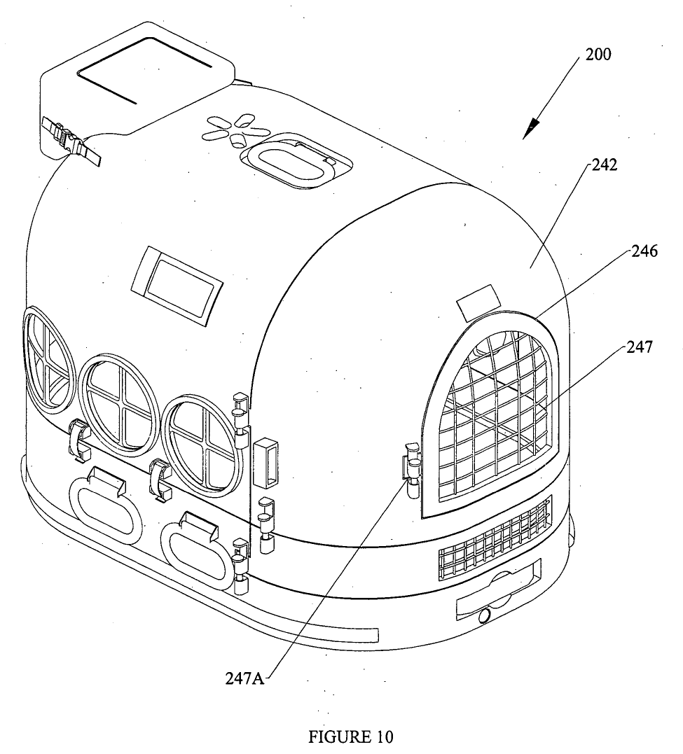

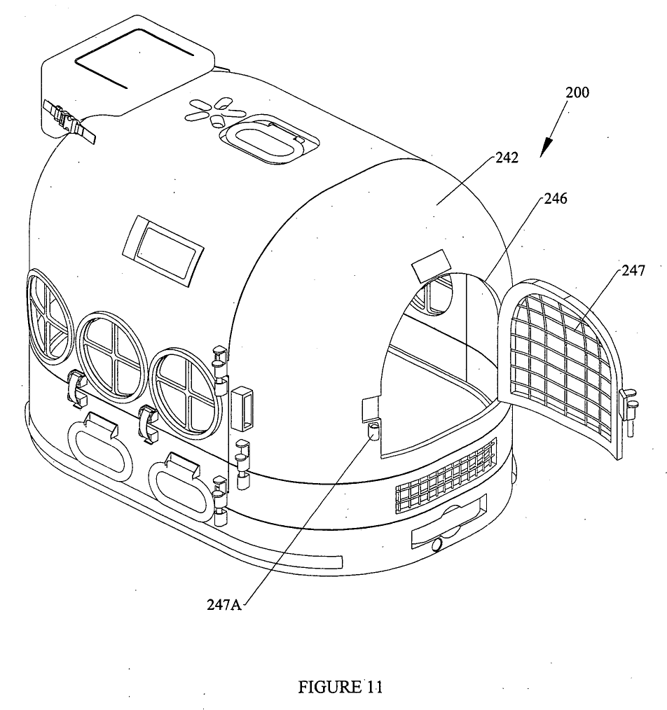

With reference to FIGS. 10 and 11, an animal carrier 200 according to further embodiments of the present invention is shown therein. The animal carrier 200 is constructed in the same manner as the animal carrier 100 except that the door 242 includes a window opening 246 and a window closure 247 over the window opening 246. The window closure 247 is hingedly coupled to the door 242 such that the window closure 247 can be selectively pivoted between a closed position as shown in FIG. 10 and an open position as shown in FIG. 11. A latch 247A is provided to selectively secure the window closure 247 in the closed position.

Other mechanisms or arrangements may be used to permit selective opening and closing of the window closure 247. For example, the window closure may be slidably mounted on the door 242 for sliding between open and closed positions. Additionally or alternatively, others of the windows 222 may be provided with selectively openable and closeable window closures.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

1. An animal carrier for transporting an animal, the carrier comprising:
a) a body defining a chamber adapted to hold the animal; and
b) an electronic tracking device mounted on the carrier.

2. The animal carrier of claim 1 wherein the electronic tracking device includes at least one of an RF transceiver, an RFID tag, and a GPS tracking module.

3. The animal carrier of claim 1 wherein the electronic tracking device includes a wireless communicator.

4. The animal carrier of claim 3 wherein the electronic tracking device includes a cellular telephone.

5. The animal carrier of claim 1 wherein the electronic tracking device includes a receiver adapted to respond to a signal from a remote transmitter.

6. The animal carrier of claim 1 further including an interior light adapted to illuminate the chamber.

7. The animal carrier of claim 6 wherein the interior light includes a passive luminescent light.

8. The animal carrier of claim 1 further including a camera mounted on the carrier.

9. The animal carrier of claim 1 further including a fan mounted on the carrier.

10. The animal carrier of claim 1 further including a sensor mounted on the carrier, wherein the sensor is adapted to detect a condition of the carrier.

11. The animal carrier of claim 1 further including a sensor mounted on the carrier, wherein the sensor is adapted to detect a condition of an animal disposed in the chamber.

12. The animal carrier of claim 1 further including an intercom mounted on the carrier.

13. An animal carrier for transporting an animal, the carrier comprising:
a) a body defining a chamber adapted to hold the animal; and
b) a sensor mounted on the carrier, wherein the sensor is adapted to detect a condition of the carrier.

14. The animal carrier of claim 13 wherein the sensor is adapted to detect mechanical impact to the carrier.

15. The animal carrier of claim 13 wherein the sensor is adapted to detect at lease one parameter of the carrier selected from the group consisting of velocity, acceleration, air pressure, humidity, air composition, temperature, radiation, altitude, and orientation.

16. The animal carrier of claim 13 further including an alarm, wherein the sensor is adapted to trigger the alarm.

17. An animal carrier for transporting an animal, the carrier comprising:
a) a body defining a chamber adapted to hold the animal; and
b) a sensor mounted on the carrier, wherein the sensor is adapted to detect a condition of an animal disposed in the chamber.

18. The animal carrier of claim 17 wherein the sensor is adapted to detect a temperature of the animal disposed in the chamber.

19. The animal carrier of claim 17 further including an alarm, wherein the sensor is adapted to trigger the alarm.

20. An animal carrier for transporting an animal, the carrier comprising:
a) a body defining a chamber adapted to hold the animal; and
b) an intercom mounted on the carrier.

21. The animal carrier of claim 20 wherein the intercom includes a wireless communicator.
